(19) United States
(12) Patent Application Publication
(10) Pub. No.: US 2026/0264522 A1
(43) Pub. Date: Sep. 10, 2026

(54) IN-VEHICLE SYSTEM, AND INFORMATION PROCESSING DEVICE

(71) Applicant: TOYOTA JIDOSHA KABUSHIKI KAISHA, Toyota-shi (JP)

(72) Inventors: Hirotake SANO, Nagakute-shi (JP); Takashi OSAWA, Toyota-shi (JP); Ryota HAMABE, Nisshin-shi (JP); Miki TSUJINO, Ichinomiya-shi (JP); Shintaro MATSUTANI, Kariya-shi (JP); Hisashi FUJIWARA, Nisshin-shi (JP)

(73) Assignee: TOYOTA JIDOSHA KABUSHIKI KAISHA, Toyota-shi (JP)

(21) Appl. No.: 19/468,323

(22) Filed: Feb. 3, 2026

(30) Foreign Application Priority Data
Feb. 10, 2025 (JP) 2025-020359

(51) Int. Cl. B60K 35/81; B60K 35/10; B60K 35/22; B60K 35/65

(52) U.S. Cl. CPC B60K 35/81; B60K 35/10; B60K 35/22; B60K 35/654; B60K 2360/1434; B60K 2360/166; B60K 2360/167; B60K 2360/18

(57) ABSTRACT

The display device includes a pair of display units each including a touch panel and disposed at positions on lateral sides of a steering wheel. In a first state in which a driver independently performs driving operations, the processor displays first information required when the driver performs the driving operations on the instrument unit and displays second information having a lower degree of necessity than the first information on the display device. In a second state in which a range of a driving assistance function performing the driving operations on behalf of the driver is broader, the processor displays the first information on the instrument unit or the display units in a smaller display range and displays the second information on the instrument unit and the display units in a larger display range than in the first state.

### CROSS-REFERENCE TO RELATED APPLICATION

This application claims priority to Japanese Patent Application No. 2025-020359 filed on Feb. 10, 2025. The disclosure of the above-identified application, including the specification, drawings, and claims, is incorporated by reference herein in its entirety.

### BACKGROUND

### 1. Technical Field

The present disclosure relates to an in-vehicle system, and an information processing device. 2. Description of Related Art

Changing a display form of a meter panel between autonomous driving and manual driving is known (e.g., refer to Japanese Unexamined Patent Application Publication No. 2018-024349 (JP 2018-024349 A)). In this case, during autonomous driving, the display of a tachometer needle and the like is omitted.

### SUMMARY

The present disclosure provides an in-vehicle system and an information processing device that display information desired by a driver on a display.

An in-vehicle system according to a first aspect of the present disclosure is an in-vehicle system of a vehicle including a driving assistance function that performs at least one of driving operations performed by a driver on behalf of the driver. The in-vehicle system includes a display device provided in front of a driver seat inside a vehicle cabin, and an information processing device configured to output information through the display device. The display device includes a pair of display units. The display units protrude rearward in a front-rear direction of the vehicle relative to an instrument unit placed on a front side of a steering wheel and are disposed at positions on lateral sides of the steering wheel. Each of the display units includes a touch panel. The information processing device includes a processor. The processor is configured to determine whether the vehicle is in a first state in which the driver independently performs the driving operations or in a second state in which a range of the driving assistance function performing the driving operations on behalf of the driver is broader than in the first state, in accordance with an input of the driver on the touch panel. The processor is configured to switch a display form of the display device between the first state and the second state. The processor is configured to, in the first state, display in real time first information required when the driver performs the driving operations in the first state on the instrument unit, in accordance with a signal from a first sensor, and display in real time second information having a lower degree of necessity than the first information in the first state on the instrument unit or the display units, in accordance with a signal from a second sensor. The processor is configured to, in the second state, display in real time the first information on the instrument unit or the display units in a smaller display range of the first information than in the first state, in accordance with a signal from the first sensor, and display in real time the second information on the instrument unit and the display units in a larger display range of the second information than in the first state, in accordance with a signal from the second sensor.

An in-vehicle system according to a second aspect of the present disclosure is a system of a vehicle including a driving assistance function that performs at least one of driving operations performed by a driver on behalf of the driver. The in-vehicle system includes a display device provided in front of a driver seat inside a vehicle cabin, and an information processing device configured to output information through the display device. The display device includes a pair of display units. The display units protrude rearward in a front-rear direction of the vehicle relative to an instrument unit placed on a front side of a steering wheel and are disposed at positions on lateral sides of the steering wheel. Each of the display units includes a touch panel. The information processing device includes a processor configured to switch a display form of the display device between a first state in which the driver independently performs the driving operations and a second state in which a range of the driving assistance function performing the driving operations on behalf of the driver is broader than in the first state. The processor is configured to, in the first state, display first information required when the driver performs the driving operations in the first state on the instrument unit, and display second information having a lower degree of necessity than the first information in the first state on the instrument unit or the display units. The processor is configured to, in the second state, display the first information on the instrument unit or the display units in a smaller display range of the first information than in the first state, and display the second information on the instrument unit and the display units in a larger display range of the second information than in the first state.

In the in-vehicle system according to the second aspect of the present disclosure, the display units may be disposed forward of gripped portions of the steering wheel in the front-rear direction of the vehicle.

In the in-vehicle system according to the second aspect of the present disclosure, the processor may be configured to make the display range of the second information larger than the display range of the first information in the second state.

In the in-vehicle system according to the second aspect of the present disclosure, the first information may be information about a speed of the vehicle.

In the in-vehicle system according to the second aspect of the present disclosure, the second information may be information about an operating status of the driving assistance function.

In the in-vehicle system according to the second aspect of the present disclosure, the second information may be information about a map.

An information processing device according to a third aspect of the present disclosure is configured to output information through a display device of a vehicle. The vehicle includes a driving assistance function that performs at least one of driving operations performed by a driver on behalf of the driver. The information processing device includes a processor configured to switch a display form of the display device between a first state in which the driver independently performs the driving operations and a second state in which a range of the driving assistance function performing the driving operations on behalf of the driver is broader than in the first state. The display device is provided in front of a driver seat inside a vehicle cabin, and includes a pair of display units. The display units protrude rearward in a front-rear direction of the vehicle relative to an instrument unit placed on a front side of a steering wheel and are disposed at positions on lateral sides of the steering wheel. Each of the display units includes a touch panel. The processor is configured to, in the first state, display first information required when the driver performs the driving operations in the first state on the instrument unit, and display second information having a lower degree of necessity than the first information in the first state on the instrument unit or the display units. The processor is configured to, in the second state, display the first information on the instrument unit or the display units in a smaller display range of the first information than in the first state, and display the second information on the instrument unit and the display units in a larger display range of the second information than in the first state.

In the information processing device according to the third aspect of the present disclosure, the display units may be disposed forward of gripped portions of the steering wheel in the front-rear direction of the vehicle.

In the information processing device according to the third aspect of the present disclosure, the processor may be configured to make the display range of the second information larger than the display range of the first information in the second state.

In the information processing device according to the third aspect of the present disclosure, the first information may be information about a speed of the vehicle.

In the information processing device according to the third aspect of the present disclosure, the second information may be information about an operating status of the driving assistance function.

In the information processing device according to the third aspect of the present disclosure, the second information may be information about a map.

Other aspects of the present disclosure are a vehicle equipped with the above-described in-vehicle system, an information processing method that is executed by the above-described information processing device, a program that makes a computer execute that information processing method, and a computer-readable storage medium that non-transitorily stores that program.

The present disclosure makes it possible to display information desired by a driver on a display.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram showing the inside of a vehicle cabin of a vehicle;

FIG. 2 is an enlarged view of a steering wheel and its surroundings;

FIG. 3 is a diagram schematically showing an example of a hardware configuration of the vehicle;

FIG. 4 is a diagram illustrating a functional configuration of an ECU;

FIG. 5 is a diagram showing an example of a screen displayed on a display device;

FIG. 6 is a diagram showing an example of the screen displayed on the display device;

FIG. 7 is a diagram showing another example of the screen displayed on the display device;

FIG. 8 is a diagram showing still another example of the screen displayed on the display device; and

FIG. 9 is a flowchart of a process in the ECU when the screen is displayed on the display device according to a first embodiment.

### DETAILED DESCRIPTION OF EMBODIMENTS

In a vehicle including a driving assistance function such as an advanced driver assistance system (ADAS), at least one of driving operations of a driver can be performed by the ADAS on behalf of the driver. Depending on the level of the driving assistance function, the driver may not need to operate an accelerator pedal, a brake, and a steering wheel. In such a case, for example, since the speed of the vehicle is controlled by the driving assistance function, the driver may not need to check a speedometer. In addition, when the speed of the vehicle is being controlled by the driving assistance function, the driver may wish to check the operating status of the driving assistance function. On the other hand, when the driver performs driving operations, the driver needs to drive while checking the speed of the vehicle on a speedometer displayed on an instrument unit. In this manner, a matter that the driver wishes to check may differ between when the driving operations are being performed by the driving assistance function and when the driving operations are not being performed by the driving assistance function.

On the other hand, an in-vehicle system that is one aspect of the present disclosure includes a display device, and an information processing device that outputs information through the display device. The display device is provided in front of a driver seat inside a vehicle cabin, and includes a pair of display units. The display units protrude rearward in a front-rear direction of the vehicle relative to an instrument unit placed on the front side of a steering wheel and are disposed at positions on lateral sides of the steering wheel. Each of the display units includes a touch panel.

The display device includes the display units disposed at the positions on the lateral sides of the steering wheel. The display units are configured to enable a touch operation through the touch panels. Preferably, the display units are disposed at positions protruding rearward in the front-rear direction of the vehicle relative to the instrument unit (typically, a meter panel on which a speedometer is disposed) placed on the front side of the steering wheel, that is, the positions closer to the driver. By providing the display units at such positions, the touch panels can be disposed near portions of the steering wheel gripped by the driver. That is, it is possible to minimize the time for which the driver takes the hands off the steering wheel during operation. Note that the steering wheel does not necessarily need to have a circular shape as long as the steering wheel includes a gripped portion and is rotated to perform a steering operation.

The display units present, for example, information about control of the vehicle or information about convenience for occupants of the vehicle to the user. The information about the convenience for the occupants of the vehicle may include information for providing entertainment to the occupants of the vehicle or information about comfort of the occupants, etc. The information about the comfort of the occupants or the convenience for the occupants includes, for example, information about an interface for performing operation of an audio device, a navigation device, an air conditioner, a telephone, a clock, a voice assistant, etc., and information about the operating status of these devices. In addition, the information about the control of the vehicle may include information about travel of the vehicle. The information about the control of the vehicle includes, for example, information about an interface for performing operation of headlights, wipers, sideview mirrors, the ADAS, a drive mode, a vehicle height, the position of the steering wheel, the position of a seat, etc., and information about the operating status of these devices.

The information processing device includes a control unit configured to execute switching a display form of the display device between a first state in which the driver independently performs the driving operations and a second state in which a range of the driving assistance function performing the driving operations on behalf of the driver is broader than in the first state. The first state is a state in which the driving load of the driver is higher than in the second state and that requires more driving operations of the driver. Note that the first state may be a state in which the driving assistance function is disabled, and the second state may be a state in which the driving assistance function is enabled. The driving assistance function includes the ADAS described above. As another example, the first state may be a state in which manual driving is being performed, and the second state may be a state in which autonomous driving is being performed. The first state and the second state may be switched, for example, in accordance with the driver's request or traveling conditions. The control unit switches the display form of the display device when a transition from the first state to the second state is made and when a transition from the second state to the first state is made.

The control unit is configured to execute, in the first state, displaying first information required when the driver performs the driving operations in the first state on the instrument unit, and displaying second information having a lower degree of necessity than the first information in the first state on the instrument unit or the display units. The first information is information required for the driver to perform the driving operations, and is, for example, information about the speed of the vehicle or an engine speed. Since the driver needs to perform the driving operations so as to adjust the speed of the vehicle in the first state, information about the speed of the vehicle is required. Thus, in the first state, the first information is preferentially displayed. On the other hand, the second information is information having a lower degree of necessity than the first information for the driver to perform the driving operations. Note that the second information may be information that enhances the convenience for the driver. For example, navigation display (route guidance) on which a route, the position of the host vehicle, and a map are displayed does not affect the driving operations of the driver even if the navigation display itself is not displayed. In addition, when the driving assistance function is disabled, display showing the operating status of the driving assistance function is not required. Thus, information that causes no problem or causes few problems for the driver to perform the driving operations even if not displayed can be regarded as information having a low degree of necessity for the driver to perform the driving operations.

In this manner, in the first state, since the first information has a higher degree of necessity than the second information, the control unit preferentially displays the first information. Thus, the control unit displays the first information in a relatively large view on the instrument unit. On the other hand, the second information may be displayed on the display units that require an increase in the amount of movement of the driver's line of sight. Thus, the control unit displays the second information on the instrument unit or the display units.

The control unit is configured to execute, in the second state, displaying the first information on the instrument unit or the display units in a smaller display range of the first information than in the first state, and displaying the second information on the instrument unit and the display units in a larger display range of the second information than in the first state. In the second state, since the range of driving operations performed by the driving assistance function on behalf of the driver expands, the driving operations of the driver are reduced. Thus, information required in the first state may be not required in the second state. For example, when the speed of the vehicle is adjusted by the driving assistance function, the degree of necessity for the driver to check information about the speed of the vehicle becomes low. Thus, in the second state, the control unit preferentially displays the second information. Therefore, the control unit displays the first information on the instrument unit or the display units while reducing the display range of the first information. On the other hand, in the second state, the control unit displays the second information on the instrument unit and the display units while making the display range of the second information larger than in the first state. That is, the second information is enlarged so as to be displayed on the instrument panel and the display units. At this time, it is only required that the second information be displayed on the instrument unit and at least one of the display units.

In this manner, by switching the display form of the display device in response to a change of information that the driver wishes to check between the first state and the second state, the information required for the driver can be provided.

In the following, embodiments of the present disclosure will be described based on the drawings. The configurations of the following embodiments are presented as examples, and the present disclosure is not limited to the configurations of the embodiments. The following embodiments can be combined as far as possible.

### First Embodiment

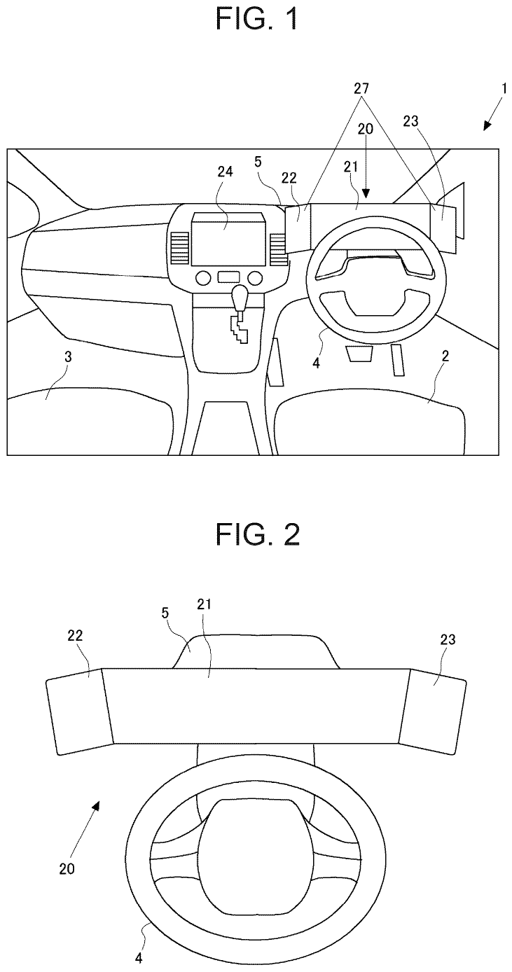

FIG. 1 is a diagram showing the inside of a vehicle cabin of a vehicle 1. As shown in the drawing, a driver seat 2 and a front passenger seat 3 are provided inside the vehicle cabin of the vehicle 1. The vehicle 1 of the present embodiment is a right-hand drive vehicle, and the driver seat 2 is provided on the right side of the vehicle 1. A steering wheel 4 is disposed in front of the driver seat 2. The steering wheel 4 may be a circular one, or a U-shaped one (a so-called irregular-shaped steering wheel) as shown in the drawing. The steering wheel 4 is connected to a steering device included in the vehicle 1 through a steering column. The steering column is covered with a column cover.

The front passenger seat 3 is provided on the left side of the driver seat 2. A center display 24 is disposed in front of a midway position between the driver seat 2 and the front passenger seat 3 in a vehicle front-rear direction. The center display 24 displays, for example, assistive information, such as car navigation, or contents about entertainment, such as audio contents or television programs.

In front of the steering wheel 4 in the vehicle front-rear direction, a display device 20 is provided. The display device 20 is provided with a meter display 21 positioned on the front side of the driver seat 2, and a pair of display devices 27 connected to the meter display 21. Each of the display devices 27 includes a touch panel display disposed at a position on each lateral side of the steering wheel 4. In the present embodiment, a display 22 disposed on the inner side of the vehicle is referred to as an inner display 22, and a display 23 disposed on the outer side of the vehicle is referred to as an outer display 23. The inner display 22 is disposed rearward of the meter display 21 in the front-rear direction of the vehicle 1 and inward of the meter display 21 in a width direction of the vehicle 1. The outer display 23 is disposed rearward of the meter display 21 in the front-rear direction of the vehicle 1 and outward of the meter display 21 in the width direction of the vehicle 1.

The outer side of the vehicle 1 means a side closer to an outside of the vehicle 1 as seen from the driver seat 2, and means the side of a door of the driver seat 2. The inner side of the vehicle 1 means the side of the front passenger seat 3 as seen from the driver seat 2, and means the side of a door of the front passenger seat 3. For example, in the vehicle 1 in which the steering wheel 4 is provided on the right side of the vehicle 1, the outer side of the vehicle 1 refers to the right side of the vehicle 1 and the inner side of the vehicle 1 refers to the left side of the vehicle 1. For example, in the vehicle 1 in which the steering wheel 4 is provided on the left side of the vehicle 1, the outer side of the vehicle 1 refers to the left side of the vehicle 1 and the inner side of the vehicle 1 refers to the right side of the vehicle 1.

A detailed structures of the inner display 22 and the outer display 23 will be described with reference to FIG. 2. FIG. 2 is an enlarged view of the steering wheel 4 and its surroundings. The display device 20 is fixed to an instrument panel 5. The meter display 21 is a horizontally-elongated display, and the inner display 22 and the outer display 23 are vertically-elongated displays.

The inner display 22 is connected to an inner end of the meter display 21 in the vehicle-width direction. The inner display 22 extends rearward in the front-rear direction of the vehicle 1 and inward in the width direction of the vehicle 1 from the inner end of the meter display 21 in the vehicle-width direction. The outer display 23 is connected to an outer end of the meter display 21 in the vehicle-width direction. The outer display 23 extends rearward in the front-rear direction of the vehicle 1 and outward in the width direction of the vehicle 1 from the outer end of the meter display 21 in the vehicle-width direction.

In this manner, the display device 20 has a shape that extends in the right-left direction (the vehicle-width direction) from an upper portion of the steering column and bends midway toward the steering wheel 4. In this manner, the inner display 22 and the outer display 23 can be disposed near gripped portions of the steering wheel 4. Each of the inner display 22 and the outer display 23 has an angle relative to the right-left direction of the steering wheel 4 and is inclined toward the steering wheel 4. That is, the inner display 22 is disposed so as to, on the inner side of the vehicle 1, protrude farther toward the rear side of the vehicle 1, and the outer display 23 is disposed so as to, on the outer side of the vehicle 1, protrude farther toward the rear side of the vehicle 1. In this manner, each of the inner display 22 and the outer display 23 is disposed so as to face the driver. The inner display 22 and the outer display 23 are disposed forward of the steering wheel 4 in the front-rear direction of the vehicle 1. The above-mentioned shape of the display device 20 enables the positions of the inner display 22 and the outer display 23 in the vehicle front-rear direction to be brought closer to the steering wheel 4. This can further reduce the amount of movement of the driver's hand when the driver performs a touch operation on the inner display 22 or the outer display 23 while driving.

Note that the above description is an example for the case in which the vehicle 1 is a right-hand drive vehicle. When the vehicle 1 is a left-hand drive vehicle, the left and right are reversed. That is, in the display device 20, the outer display 23 is connected to a left end when facing forward of the vehicle, and the inner display 22 is connected to a right end when facing forward of the vehicle.

The meter display 21, the inner display 22, and the outer display 23 are all displays including a touch panel. It is only required that at least the inner display 22 and the outer display 23 include the touch panel. As the touch panel, for example, a pressure-sensitive touch panel that detects a pressure with which a user presses the panel, or a capacitive touch panel that detects a change in capacitance when a user presses the panel can be adopted. The display is, for example, a liquid crystal display (LCD) or an electroluminescence (EL) panel.

The meter display 21 is a display that provides various information to the driver of the vehicle 1. The meter display 21 displays information required for travel of the vehicle, such as a speed of the vehicle (vehicle speed), an engine speed (when the vehicle 1 includes an engine), a charge-discharge status (when the vehicle 1 includes a driving battery), and a travel distance. The meter display 21 displays an operating status of the ADAS or a map indicating a route. The meter display 21 is one example of the “instrument unit” in the present disclosure.

The inner display 22 displays, for example, information about convenience for occupants of the vehicle 1. The information about the convenience for the occupants of the vehicle 1 includes information for providing entertainment to the occupants of the vehicle 1. The information about the convenience for the occupants of the vehicle 1 may include, for example, information about comfort of the occupants. The information about the comfort of the occupants or the convenience for the occupants includes, for example, information about switches and buttons for performing operation of an audio device, operation of a navigation device, operation of an air conditioner, operation of a telephone, operation of a clock, operation of an AI partner (voice assistant), etc., and information about the operating status of these devices.

The outer display 23 displays, for example, information about control of the vehicle 1. The information about the control of the vehicle 1 includes, for example, information about travel of the vehicle 1. The information about the control of the vehicle 1 includes, for example, information about switches and buttons for performing operation of power windows, operation of headlights, operation of wipers, operation of sideview mirrors, operation of the ADAS, operation of a drive mode, operation of a suspension, operation of the position of the steering wheel, operation of the position of a seat, etc., and information about the operating status of these devices. Displaying the information about the control of the vehicle 1 on the outer display 23 can restrain a passenger other than the driver from operating the information about the control of the vehicle 1.

The information to be displayed on the inner display 22 and the outer display 23 is not limited to those mentioned above. The inner display 22 may display the information about the control of the vehicle 1, and the outer display 23 may display the information about the convenience for the occupants of the vehicle 1. The information to be displayed on the inner display 22 and the outer display 23 can also be arbitrarily determined. As will be described further below, information about an indicator displayed on the meter display 21 is displayed on the inner display 22 or the outer display 23.

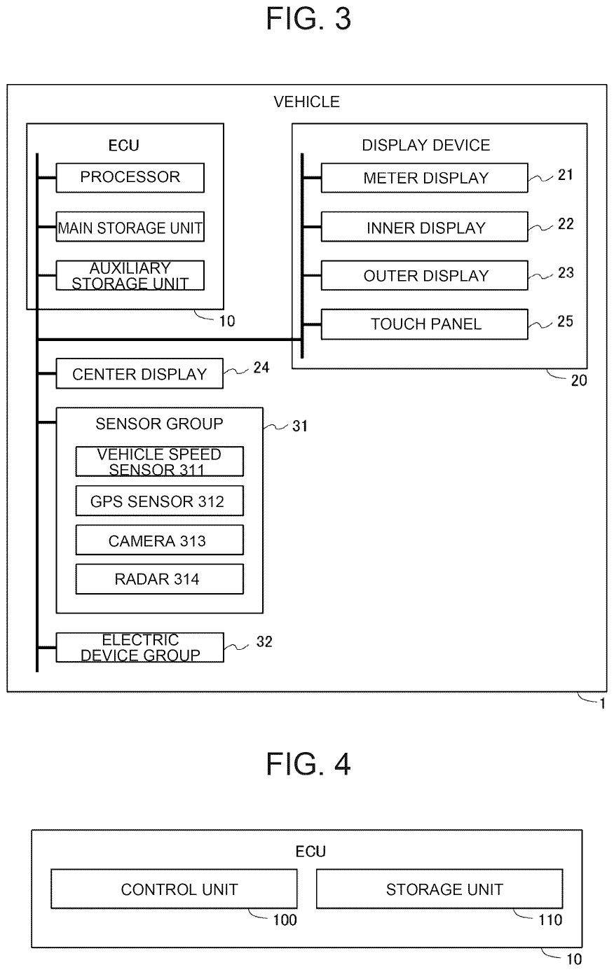

FIG. 3 is a diagram schematically showing an example of a hardware configuration of the vehicle 1. The vehicle 1 includes an ECU 10, the display device 20, the center display 24, a sensor group 31, and an electric device group 32. The ECU 10 can be configured as a computer including a processor (a CPU, a GPU, etc.), a main storage device (a RAM, a ROM, etc.), and an auxiliary storage device (an EPROM, a hard disc drive, a removable medium, etc.). The auxiliary storage device stores an operating system (OS), various programs, various tables, etc., and by executing a program stored in the auxiliary storage device, it is possible to implement each function (software module) matching a predetermined purpose, as will be described further below. However, some or all of the functions may be implemented as hardware modules using a hardware circuit, such as an ASIC or an FPGA. The display device 20, the center display 24, the sensor group 31, and the electric device group 32 are connected to the ECU 10. The ECU 10 is an example of the information processing device.

The display device 20 includes the meter display 21, the inner display 22, the outer display 23, and a touch panel 25. The touch panel 25 is a unit for detecting touch operations performed on the meter display 21, the inner display 22, and the outer display 23. The touch panel 25 is disposed on each of the meter display 21, the inner display 22, and the outer display 23, enabling operations by touches.

The sensor group 31 is a group of a plurality of sensors for acquiring sensor data that is used in travel of the vehicle 1. The sensors may acquire physical quantities or may acquire image data, etc. The sensor group 31 includes, for example, a sensor that detects the state of the vehicle 1 and a sensor that detects the action of the driver. The sensor group 31 includes, for example, a vehicle speed sensor 311 that detects the speed of the vehicle 1, an acceleration sensor, an accelerator operation amount sensor that detects the position of the accelerator pedal, a brake sensor that detects the position of the brake pedal, a steering wheel angle sensor that detects the angle of the steering wheel, an engine speed sensor that detects an engine speed, a coolant temperature sensor that detects the temperature of a coolant of the engine, an oil temperature sensor that detects the temperature of oil of the engine, an oil pressure sensor that detects the pressure of the oil of the engine, a sensor that detects an intake pressure of the engine, a yaw rate sensor, a blinker switch sensor (the sensor that detects the state of a switch for a turn signal), a shift position sensor, a sensor that detects position information (a GPS sensor 312), a sensor that detects a temperature inside the vehicle, a sensor that detects a temperature outside the vehicle, and a camera 313 and a radar 314 that measure the distance to an object.

The electric device group 32 is a group of electric devices used in the vehicle 1. The electric device group 32 may include the power windows, the air conditioner, the suspension, a massage seat, the navigation device, the audio device, the telephone, the wipers, the headlights, the sideview mirrors, and the voice assistant. The electric device group 32 also includes actuators for operating the accelerator pedal, the brake, and the steering wheel 4 that are controlled in the ADAS.

FIG. 4 is a diagram illustrating a functional configuration of the ECU 10. The ECU 10 includes a control unit 100 and a storage unit 110 as functional constituent elements. The control unit 100 is a functional constituent element that is provided, for example, by a processor executing various programs stored in an auxiliary storage unit. The storage unit 110 is means for storing information and configured to include a main storage unit and the auxiliary storage unit.

The control unit 100 includes the functions of the ADAS. In accordance with signals from the sensor group 31 including the vehicle speed sensor 311, the camera 313, the radar 314, etc., the control unit 100 outputs signals and warning sounds for operating the accelerator pedal, the brake, and the steering wheel 4. The ADAS may include, for example, cruise control, autonomous emergency braking, lane keep assist, parking assist, and blind spot monitor. The control unit 100 displays a graphical user interface (GUI) component for enabling and disabling the functions of the ADAS on an ADAS setting screen displayed on the outer display 23, and enables and disables the functions of the ADAS in accordance with the driver's touch position on the touch panel 25. The control unit 100 also displays in real time the operating status of the ADAS on the display device 20. The control unit 100 outputs in real time, to the display device 20, a command for displaying the operating status of the ADAS on the display device 20.

In addition, the control unit 100 includes the function of route guidance. The control unit 100 executes route search in accordance with a signal from the GPS sensor 312 and a destination input by a user on the touch panel 25. At this time, the control unit 100 searches for a route in accordance with a logic stored in the storage unit 110. Map information used at this time is stored in the storage unit 110. The control unit 100 outputs in real time, to the display device 20, a command for displaying the searched route, the position of the host vehicle, and the map on the display device 20.

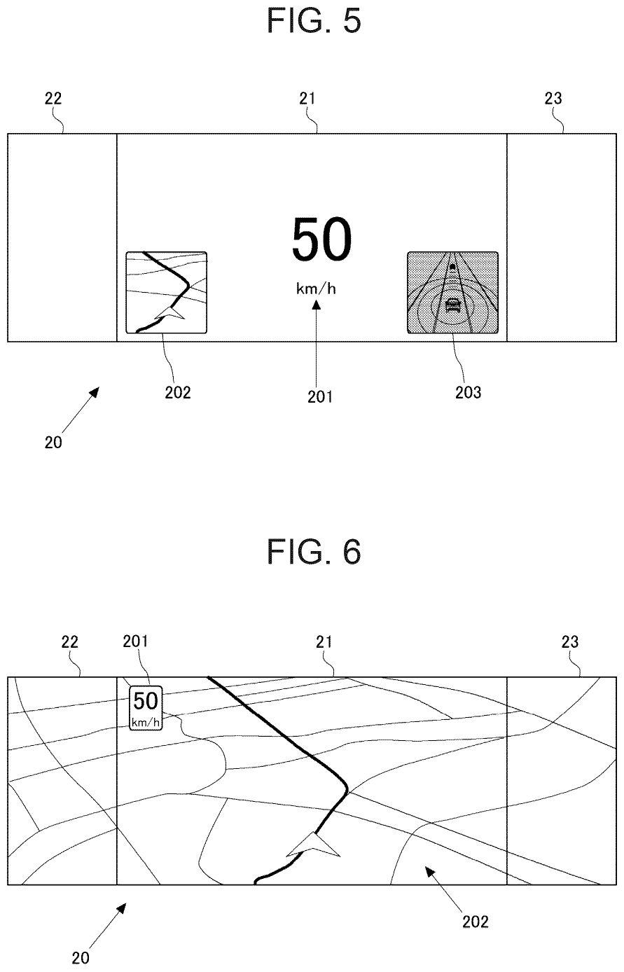

The control unit 100 generates a screen to be displayed on the display device 20. FIG. 5 is a diagram showing an example of the screen displayed on the display device 20. Note that FIG. 5 shows the meter display 21, the inner display 22, and the outer display 23 on the same plane. The example shown in FIG. 5 shows an example of the screen displayed on the display device 20 when a driving load of the driver is relatively high. The case in which the driving load of the driver is relatively high is, for example, a case in which at least one of the functions of the ADAS is disabled, or a case in which manual driving is being performed instead of autonomous driving in the vehicle 1 capable of autonomous driving.

For example, a vehicle speed 201 is displayed in real time on the meter display 21. The control unit 100 detects the vehicle speed in accordance with a signal from the vehicle speed sensor 311 and outputs in real time, to the display device 20, a command for displaying the vehicle speed on the display device 20. In addition, in the example shown in FIG. 5, a map 202 including the route and the position of the host vehicle is displayed in real time on the meter display 21. Furthermore, since the ADAS is disabled, an ADAS operating status 203 is grayed out. When the ADAS is disabled, the ADAS operating status 203 does not need to be displayed on the display device 20.

Note that various indicators, an outside air temperature, a coolant temperature, a clock, an odometer, a fuel gauge, etc., may be additionally displayed on the meter display 21. These are displayed in accordance with signals from the sensor group 31. Although not shown in FIG. 5, the information about the convenience for the occupants of the vehicle 1 is displayed on the inner display 22, and the information about the control of the vehicle 1 is displayed on the outer display 23. In addition, the map 202 may be displayed on the inner display 22, and the ADAS operating status 203 may be displayed on the outer display 23.

The driver needs to drive such that the vehicle speed does not exceed a speed limit on a road. Thus, typically, the vehicle speed 201 is displayed in a large size in a relatively conspicuous place on the meter display 21. On the other hand, when the functions of the ADAS are enabled and when autonomous driving is being performed instead of manual driving, the vehicle speed is controlled by the control unit 100 of the vehicle 1. Thus, the driver may be able to perform the driving operations without paying much attention to the vehicle speed. In such a case in which the driving load of the driver is relatively low, information of the vehicle speed 201 displayed on the meter display 21 may be information having a low degree of necessity (or may be a low degree of importance) for the driver. In this case, other information has a higher degree of necessary. For example, the information shown on the map 202 may have a higher degree of necessity for the driver. However, as shown in FIG. 5, when the map 202 and the like are displayed in a small size, the map 202 and the like are difficult for the driver to see. In addition, when the ADAS is enabled, checking the ADAS operating status 203 may have a higher degree of necessity for the driver than checking the vehicle speed 201.

Thus, the control unit 100 displays information having a lower degree of necessity (e.g., the vehicle speed 201) in a smaller view and displays information having a higher degree of necessity (e.g., the map 202, and the ADAS operating status 203) in a larger view when the driving load of the driver is low than when the driving load of the driver is high. In addition, when the information having a higher degree of necessity is displayed in an enlarged view, the control unit 100 expands a display range up to at least one of the inner display 22 and the outer display 23. FIG. 6 is a diagram showing an example of the screen displayed on the display device 20. Note that FIG. 6 shows the meter display 21, the inner display 22, and the outer display 23 on the same plane. The example shown in FIG. 6 shows an example of the screen displayed on the display device 20 when the driving load of the driver is relatively low. The case in which the driving load of the driver is relatively low is, for example, at least one of a case in which the functions of the ADAS are enabled and a case in which autonomous driving is being performed instead of manual driving.

In the example shown in FIG. 6, the control unit 100 displays the map 202 in an enlarged view up to the inner display 22 and the outer display 23. In addition, the control unit 100 displays the vehicle speed 201 in a reduced view on an upper left portion of the meter display 21. The position at which the vehicle speed 201 is displayed is not limited to this position. For example, the vehicle speed 201 may be displayed on the inner display 22 or the outer display 23. The control unit 100 may display the ADAS operating status 203 on at least one of the meter display 21, the inner display 22, and the outer display 23. In this manner, the control unit 100 preferentially displays information having a high degree of necessity in an enlarged view, thereby enabling the screen that meets the user's need to be displayed.

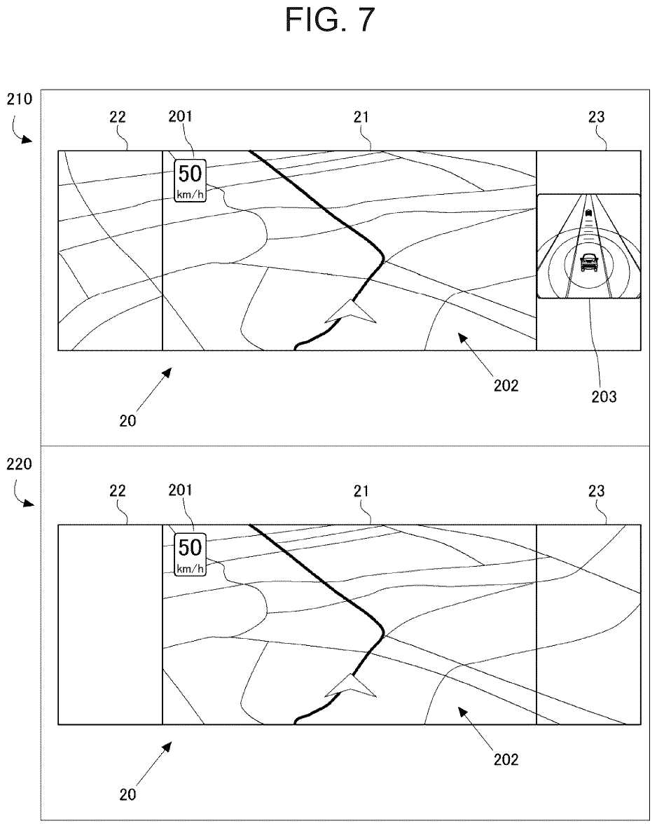

FIG. 7 is a diagram showing another example of the screen displayed on the display device 20. Reference numeral 210 indicates a case in which when the control unit 100 displays information having a high degree of necessity in an enlarged view, the control unit 100 expands the display range up to the inner display 22, and reference numeral 220 indicates a case in which when the control unit 100 displays information having a high degree of necessity in an enlarged view, the control unit 100 expands the display range up to the outer display 23. In this manner, the control unit 100 may display the enlarged view on only one of the inner display 22 and the outer display 23. As indicated by reference numeral 210, the ADAS operating status 203 may be displayed on the outer display 23 on which the map 202 is not displayed. At this time, the control unit 100 may make a display area for the ADAS operating status 203 larger than when the driving load of the driver is relatively high.

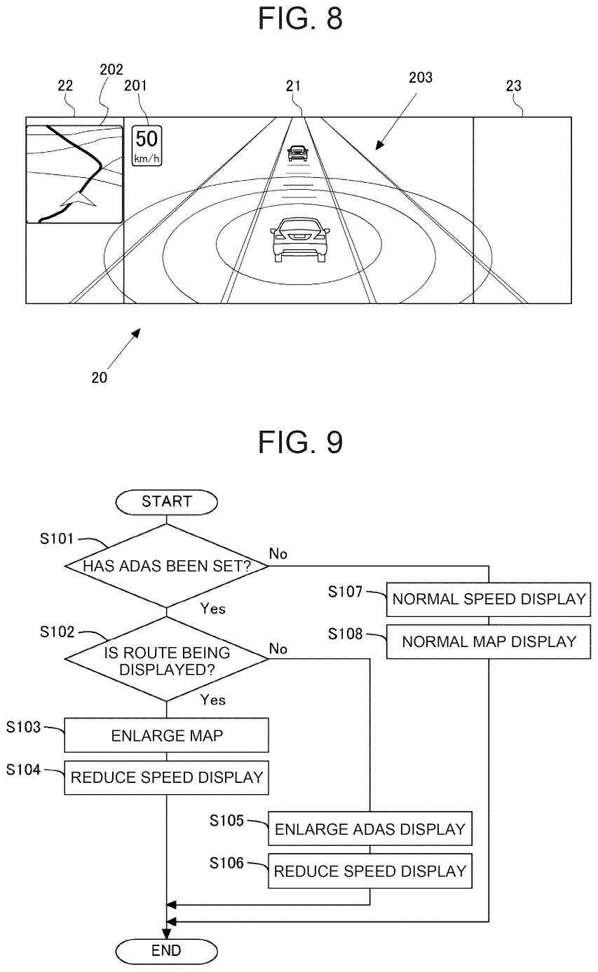

FIG. 8 is a diagram showing still another example of the screen displayed on the display device 20. Note that FIG. 8 shows the meter display 21, the inner display 22, and the outer display 23 on the same plane. The example shown in FIG. 8 shows an example of the screen displayed on the display device 20 when the driving load of the driver is relatively low.

The control unit 100 displays the ADAS operating status 203 in an enlarged view on the meter display 21, the inner display 22, and the outer display 23. Since the ADAS is enabled, the ADAS operating status 203 is displayed without being grayed out. In addition, the control unit 100 displays the vehicle speed 201 in a reduced view on the upper left portion of the meter display 21. In addition, the control unit 100 displays the map 202 on the inner display 22. At this time, the control unit 100 may make a display area for the map 202 larger than when the driving load of the driver is relatively high. The position at which the vehicle speed 201 is displayed is not limited to this position. For example, the vehicle speed 201 may be displayed on the inner display 22 or the outer display 23. In this manner, the convenience for the user is enhanced by the control unit 100 preferentially displaying information having a high degree of necessity in an enlarged view. In addition, in FIG. 8, it is not essential for the control unit 100 to display the map 202. In addition, the map 202 may be displayed on at least one of the meter display 21, the inner display 22, and the outer display 23.

FIG. 9 is a flowchart of a process in the ECU 10 when the screen is displayed on the display device 20 according to the first embodiment. The process shown in FIG. 9 is repeatedly executed at predetermined time intervals in the ECU 10.

In step S101, the control unit 100 determines whether the driver has enabled the ADAS. The ADAS setting screen is displayed on the outer display 23. The control unit 100 determines whether the driver has touched a predetermined GUI component that enables the ADAS on the ADAS setting screen displayed on the outer display 23, in accordance with a touch signal from the touch panel 25. The position of the predetermined GUI component is stored in the storage unit 110. Then, the control unit 100 enables the ADAS in response to the driver touching the predetermined GUI component. When the control unit 100 makes an affirmative determination in step S101, the process proceeds to step S102, and when the control unit 100 makes a negative determination, the process proceeds to step S107.

In step S102, the control unit 100 determines whether the map 202 is being displayed on the meter display 21. For example, the map 202 may be displayed on the meter display 21 by the driver touching a GUI component that displays the map 202 on an operation screen of the navigation device displayed on the inner display 22. When the control unit 100 makes an affirmative determination in step S102, the process proceeds to step S103, and when the control unit 100 makes a negative determination, the process proceeds to step S105.

In step S103, the control unit 100 displays the map 202 in an enlarged view (refer to FIGS. 6 and 7). At this time, the control unit 100 transmits, to the display device 20, a command for displaying the map 202 in an enlarged view on the meter display 21 and at least one of the inner display 22 and the outer display 23. At this time, a command for displaying the ADAS operating status 203 on at least one of the meter display 21, the inner display 22, and the outer display 23 may also be transmitted to the display device 20. When the process of step S103 is completed, the process proceeds to step S104.

In step S104, the control unit 100 displays the vehicle speed 201 in a reduced view (refer to FIGS. 6 and 7). At this time, the control unit 100 transmits, to the display device 20, a command for displaying the vehicle speed 201 in a reduced view at a predetermined position on the meter display 21. The predetermined position may be specified by the driver. When the process in step S104 is completed, the routine is finished.

In step S105, the control unit 100 displays the ADAS operating status 203 in an enlarged view (refer to FIG. 8). At this time, the control unit 100 transmits, to the display device 20, a command for displaying the ADAS operating status 203 in an enlarged view on the meter display 21, and at least one of the inner display 22 and the outer display 23. When the process in step S105 is completed, the process proceeds to step S106.

In step S106, the control unit 100 displays the vehicle speed 201 in a reduced view (refer to FIG. 8). At this time, the control unit 100 transmits, to the display device 20, a command for displaying the vehicle speed 201 in a reduce view at a predetermined position on the meter display 21. The predetermined position may be specified by the driver. When the process in step S106 is completed, the routine is finished.

In step S107, the control unit 100 displays the vehicle speed 201 in a normal range (refer to FIG. 5). The normal range is a range in which the vehicle speed 201 is displayed when the driving load is relatively high. At this time, the control unit 100 transmits, to the display device 20, a command for displaying the vehicle speed 201, for example, in the center of the meter display 21. When the process in step S107 is completed, the process proceeds to step S108.

In step S108, the control unit 100 displays the map 202 in a normal range (refer to FIG. 5). The normal range described herein is a range in which the map 202 is displayed when the driving load is relatively high. At this time, the control unit 100 transmits, to the display device 20, a command for displaying the map 202 at a predetermined position on the meter display 21. The predetermined position may be specified by the driver. When the process in step S108 is completed, the routine is finished.

As described above, with the present embodiment, since the display form of the display device 20 is changed between when the driving load is high and when the driving load is low, it is possible to preferentially display information having a high degree of necessity for the driver depending on the current situation. In addition, when the driving load is relatively low, since the content with a higher priority is displayed in an enlarged view up to the inner display 22 and the outer display 23, the content is made easy for the user to see.

### Other Embodiments

The above-described embodiment is merely an example, and the present disclosure can be implemented with changes made thereto as appropriate within such a range that no departure is made from the gist of the disclosure. The processes and means having been described in the present disclosure can be implemented in arbitrary combinations to such an extent that no technical inconsistency arises. A process that has been described as being performed by one device may be shared and executed by a plurality of devices. Alternatively, processes that have been described as being performed by different devices may be executed by one device. What hardware configuration is used to realize each function in a computer system can be flexibly changed.

Although, in the first embodiment, the inner display 22 and the outer display 23 are directly connected to the lateral sides of the meter display 21, this is not a limitation. Another display may be interposed between the displays. In this case, each display may be bent or curved such that the angle of the display is changed. In this case, the other display may be treated as being equivalent to the inner display 22 or the outer display 23.

The present disclosure can also be realized by supplying a computer program provided with the functions described in the above-described embodiments to a computer, and making one or more processors included in that computer read and execute the program. Such a computer program may be provided to a computer by a non-transitory computer-readable storage medium that can be connected to a system bus of the computer, or may be provided to a computer through a network. Examples of non-transitory computer-readable storage media include arbitrary types of discs such as magnetic discs (a floppy (R) disk, a hard disc drive (HDD), etc.) and optical discs (a CD-ROM, a DVD disc, a Blu-ray disc, etc.), a read-only memory (ROM), a random-access memory (RAM), an EPROM, an EEPROM, a magnetic card, a flash memory, an optical card, and arbitrary types of media suitable for storing electronic instructions.

What is claimed is:

1. An in-vehicle system of a vehicle including a driving assistance function that performs at least one of driving operations performed by a driver on behalf of the driver, the in-vehicle system comprising:
a display device provided in front of a driver seat inside a vehicle cabin, the display device including a pair of display units, the display units protruding rearward in a front-rear direction of the vehicle relative to an instrument unit placed on a front side of a steering wheel and being disposed at positions on lateral sides of the steering wheel, each of the display units including a touch panel; and
an information processing device configured to output information through the display device,
the information processing device including a processor configured to
determine whether the vehicle is in a first state in which the driver independently performs the driving operations or in a second state in which a range of the driving assistance function performing the driving operations on behalf of the driver is broader than in the first state, in accordance with an input of the driver on the touch panel, and
switch a display form of the display device between the first state and the second state, wherein
the processor is configured to:
in the first state,
display in real time first information required when the driver performs the driving operations in the first state on the instrument unit, in accordance with a signal from a first sensor, and
display in real time second information having a lower degree of necessity than the first information in the first state on the instrument unit or the display units, in accordance with a signal from a second sensor; and
in the second state,
display in real time the first information on the instrument unit or the display units in a smaller display range of the first information than in the first state, in accordance with a signal from the first sensor, and
display in real time the second information on the instrument unit and the display units in a larger display range of the second information than in the first state, in accordance with a signal from the second sensor.

2. An in-vehicle system of a vehicle including a driving assistance function that performs at least one of driving operations performed by a driver on behalf of the driver, the in-vehicle system comprising:
a display device provided in front of a driver seat inside a vehicle cabin, the display device including a pair of display units, the display units protruding rearward in a front-rear direction of the vehicle relative to an instrument unit placed on a front side of a steering wheel and being disposed at positions on lateral sides of the steering wheel, each of the display units including a touch panel; and
an information processing device configured to output information through the display device, the information processing device including a processor configured to switch a display form of the display device between a first state in which the driver independently performs the driving operations and a second state in which a range of the driving assistance function performing the driving operations on behalf of the driver is broader than in the first state, wherein
the processor is configured to:
in the first state,
display first information required when the driver performs the driving operations in the first state on the instrument unit, and
display second information having a lower degree of necessity than the first information in the first state on the instrument unit or the display units; and
in the second state,
display the first information on the instrument unit or the display units in a smaller display range of the first information than in the first state, and
display the second information on the instrument unit and the display units in a larger display range of the second information than in the first state.

3. The in-vehicle system according to claim 2, wherein the display units are disposed forward of gripped portions of the steering wheel in the front-rear direction of the vehicle.

4. The in-vehicle system according to claim 2, wherein the processor is configured to make the display range of the second information larger than the display range of the first information in the second state.

5. The in-vehicle system according to claim 2, wherein the first information is information about a speed of the vehicle.

6. The in-vehicle system according to claim 2, wherein the second information is information about an operating status of the driving assistance function.

7. The in-vehicle system according to claim 2, wherein the second information is information about a map.

8. An information processing device configured to output information through a display device of a vehicle, the vehicle including a driving assistance function that performs at least one of driving operations performed by a driver on behalf of the driver, the information processing device comprising a processor configured to switch a display form of the display device between a first state in which the driver independently performs the driving operations and a second state in which a range of the driving assistance function performing the driving operations on behalf of the driver is broader than in the first state, wherein:
the display device
is provided in front of a driver seat inside a vehicle cabin, and
includes a pair of display units, the display units protruding rearward in a front-rear direction of the vehicle relative to an instrument unit placed on a front side of a steering wheel and being disposed at positions on lateral sides of the steering wheel, each of the display units including a touch panel; and
the processor is configured to:
in the first state,
display first information required when the driver performs the driving operations in the first state on the instrument unit, and
display second information having a lower degree of necessity than the first information in the first state on the instrument unit or the display units; and
in the second state,
display the first information on the instrument unit or the display units in a smaller display range of the first information than in the first state, and
display the second information on the instrument unit and the display units in a larger display range of the second information than in the first state.

9. The information processing device according to claim 8, wherein the display units are disposed forward of gripped portions of the steering wheel in the front-rear direction of the vehicle.

10. The information processing device according to claim 8, wherein the processor is configured to make the display range of the second information larger than the display range of the first information in the second state.

11. The information processing device according to claim 8, wherein the first information is information about a speed of the vehicle.

12. The information processing device according to claim 8, wherein the second information is information about an operating status of the driving assistance function.

13. The information processing device according to claim 8, wherein the second information is information about a map.
